(19) United States
(12) Patent Application Publication
(10) Pub. No.: US 2024/0400048 A1
(43) Pub. Date: Dec. 5, 2024

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Satoshi Sadamura, Tokyo (JP); Yoshihiko Kosegaki, Tokyo (JP)

(21) Appl. No.: 18/732,666

(22) Filed: Jun. 4, 2024

(30) Foreign Application Priority Data
Jun. 5, 2023 (JP) 2023-092273

(51) Int. Cl. B60W 30/14

(52) U.S. Cl. CPC B60W 30/143; B60W 2552/30; B60W 2720/10

(57) ABSTRACT

A vehicle control device includes a hardware processor, in which the hardware processor executes a program stored in a storage device, thereby acquiring first information related to a curved road that is present in a traveling direction of a vehicle, acquiring second information including an amount of a deceleration operation of a driver of the vehicle, performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has approached further toward the entrance of the curved road, referring to the second information during execution of the deceleration control, and stopping the deceleration control when the amount of a deceleration operation is equal to or greater than a predetermined amount, and in which the predetermined amount is set to be equal to or greater than the second deceleration rate.

### CROSS-REFERENCE TO RELATED APPLICATION

Priority is claimed on Japanese Patent Application No. 2023-092273, filed on Jun. 5, 2023, the contents of which are incorporated herein by reference.

### BACKGROUND

### Field of the Invention

The present invention relates to a vehicle control device, a vehicle control method, and a storage medium.

### Description of Related Art

In recent years, efforts to provide sustainable transportation systems that take various situations into account have been made more actively. To achieve this goal, research and development that will further improve traffic safety and convenience through research and development on driving support technology has been focused upon. For example, an automatic brake device has been disclosed that applies braking force to a vehicle before it enters a curve until it reaches a safe speed at which it can safely enter the curve (for example, refer to Japanese Patent No. 5190022). This automatic brake device determines whether a distance to the entrance of the curve is equal to or greater than a predetermined distance, and when it determines that the distance is equal to or greater than the predetermined distance, it determines whether the driver intends to accelerate, and reduces the braking force accordingly.

With conventional devices, vehicle control according to an intention of the driver may not be able to be realized in some cases. For example, there have been some cases in which the vehicle could not be made to accelerate according to the intention of the driver.

The present invention has been made in consideration of such circumstances, and can realize control of a vehicle according to an intention of a driver. For example, it is possible to cause the vehicle to accelerate according to the intention of the driver. In addition, it will be possible to contribute to the development of a sustainable transportation system with consideration for passengers.

### SUMMARY

A vehicle control device, a vehicle control method, and a storage medium according to the present invention have adopted the following configuration.

(1): A vehicle control device according to one aspect of the present invention includes a first acquisition unit that acquires first information on a curved road present in a traveling direction of a vehicle, a second acquisition unit that acquires second information including an amount of a deceleration operation of a driver of the vehicle, and a control unit that performs a deceleration control that causes the vehicle to decelerate so that a speed of the vehicle approaches a target speed based on the first information when the vehicle is traveling in a section from an entrance of the curved road to a predetermined distance before the entrance or on the curved road, and a deceleration control that causes the vehicle to decelerate at a first deceleration rate when the vehicle has reached a start point of the section and causes the vehicle to decelerate at a second deceleration rate greater than the first deceleration rate when the vehicle has approached further toward the entrance of the curved road, in which the control unit refers to the second information during execution of the deceleration control, and stops the deceleration control when the amount of a deceleration operation is equal to or greater than a predetermined amount, and in which the predetermined amount is set to be equal to or greater than the second deceleration rate.

(2): In the aspect of (1) described above, the control unit may stop the deceleration control when the amount of a deceleration operation has continued to be equal to or greater than the predetermined amount for a predetermined period of time or more.

(3): In the aspect of (1) described above, the control unit may stop the deceleration control when an average value of the amount of a deceleration operation for a predetermined period of time is equal to or greater than the predetermined amount.

(4): A vehicle control method according to another aspect of the present invention includes, by a computer, acquiring first information related to a curved road that is present in a traveling direction of a vehicle, acquiring second information including an amount of a deceleration operation of a driver of the vehicle, performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has further approached the entrance of the curved road, referring to the second information during execution of the deceleration control, and stopping the deceleration control when the amount of a deceleration operation is equal to or greater than a predetermined amount, in which the predetermined amount is set to be equal to or greater than the second deceleration rate.

(5): A computer-readable non-transitory storage medium according to still another aspect of the present invention stores a program causing a computer to execute acquiring first information related to a curved road that is present in a traveling direction of a vehicle, acquiring second information including an amount of a deceleration operation of a driver of the vehicle, performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has further approached the entrance of the curved road, referring to the second information during execution of the deceleration control, and stopping the deceleration control when the amount of a deceleration operation is equal to or greater than a predetermined amount, in which the predetermined amount is set to be equal to or greater than the second deceleration rate.

According to the aspects (1) to (5), the vehicle control device, the vehicle control method, or the storage medium refers to the second information during the execution of the deceleration control, and stops the deceleration control when the amount of a deceleration operation is equal to or greater than a predetermined amount, and the predetermined amount is set to be equal to or greater than the second deceleration rate, thereby making it possible to control the vehicle according to an intention of the driver. In particular, by setting the predetermined amount to be equal to or greater than the second deceleration rate, it is possible to prevent a situation where the deceleration control is overridden in a state where deceleration is not sufficient for a curved road.

According to the aspect (2), it is possible to prevent a situation where the deceleration control is unintentionally overridden due to, for example, a reflexive deceleration operation in response to a warning by the driver.

According to the aspect (3), for example, even if the driver intends to override the deceleration control, when the deceleration operation is momentarily stopped, the deceleration control can be overridden as intended.

### DESCRIPTION OF EMBODIMENTS

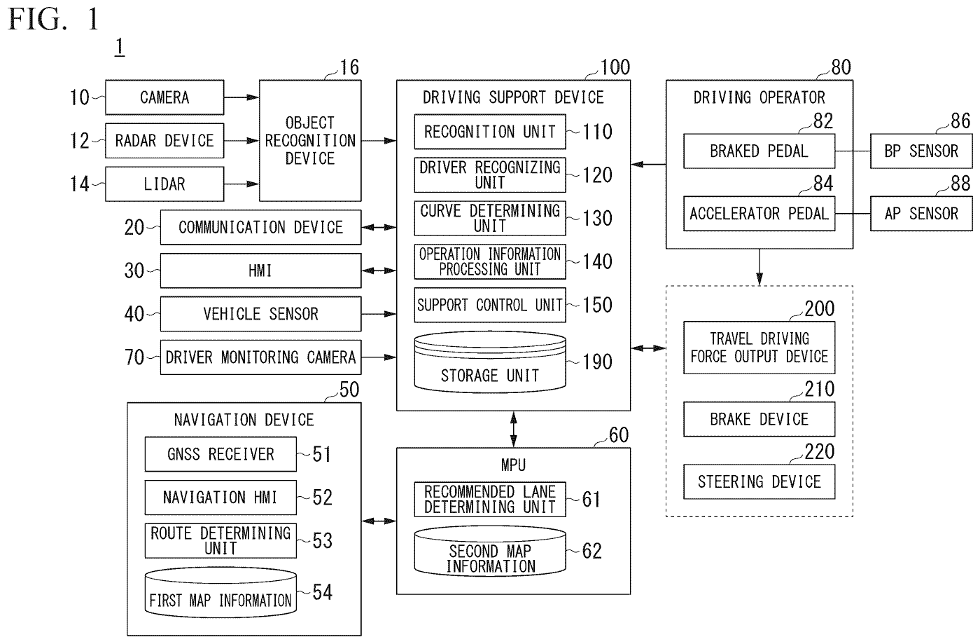

FIG. 1 is a configuration diagram of a vehicle system using a vehicle control system according to an embodiment.

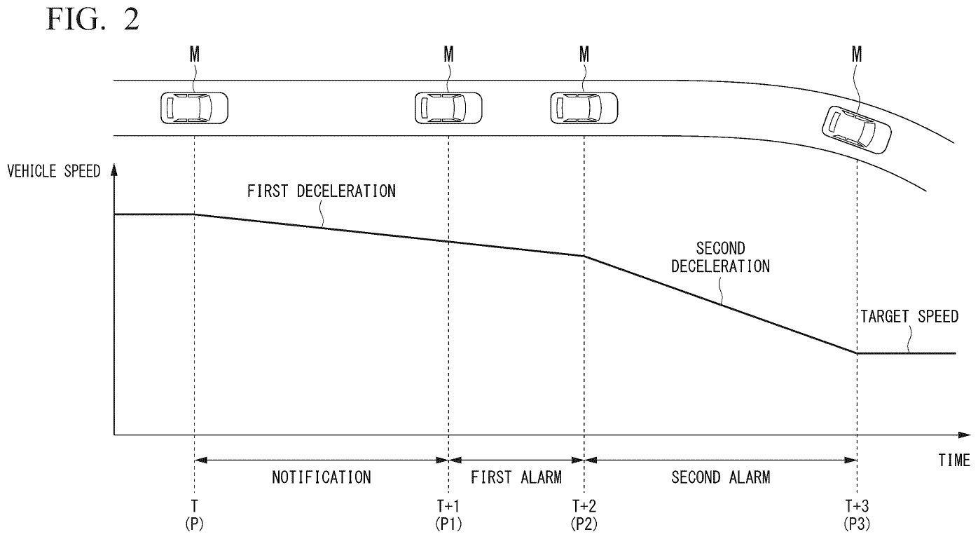

FIG. 2 is a diagram which shows an example of driving support control.

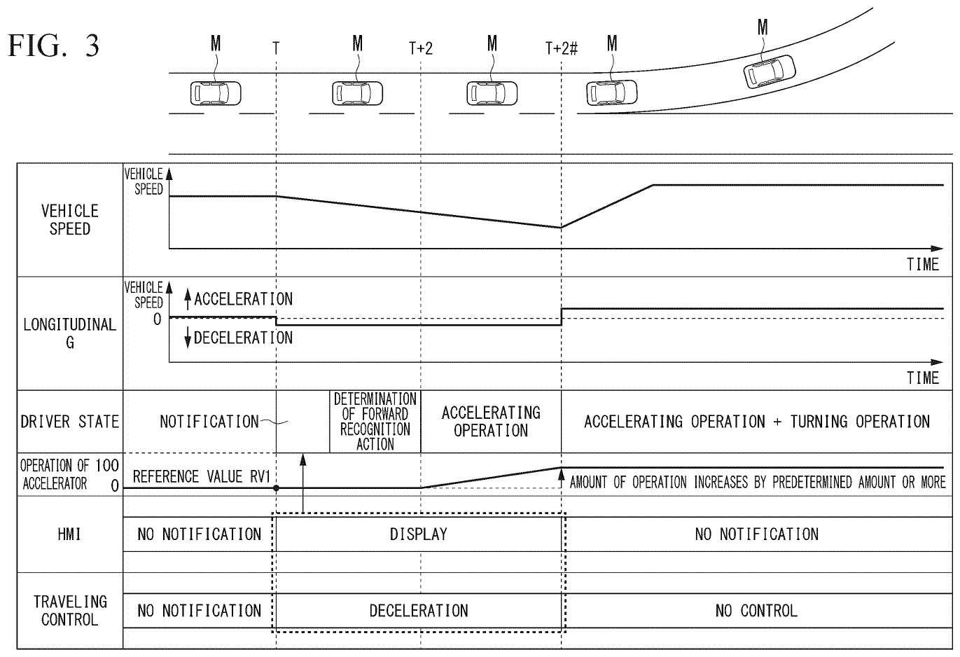

FIG. 3 is a diagram for describing a first aspect of brake override.

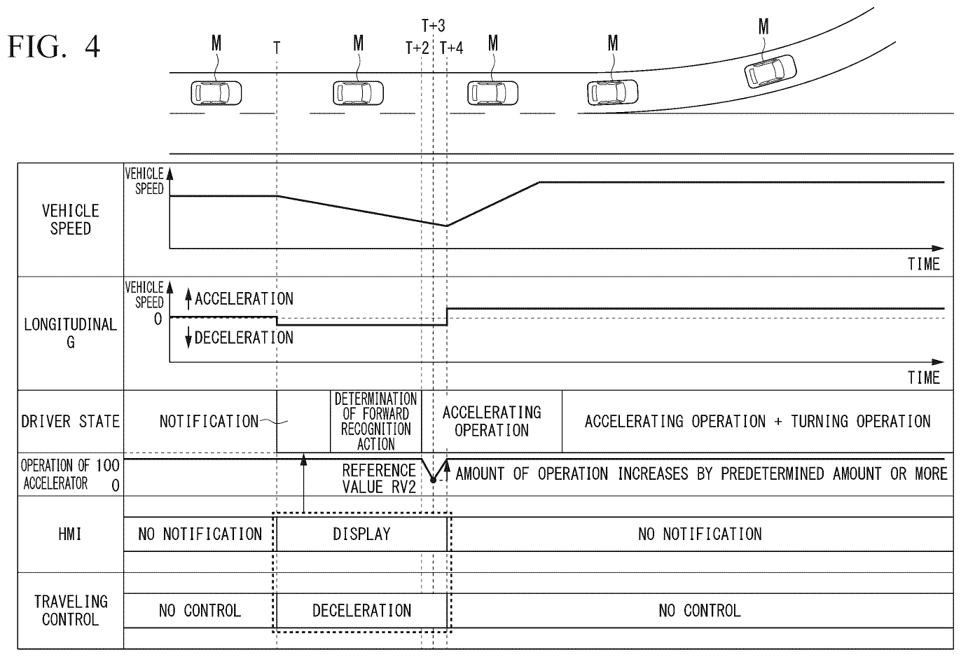

FIG. 4 is a diagram for describing a second aspect of brake override.

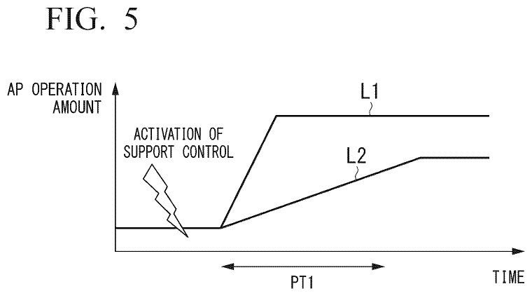

FIG. 5 is a flowchart which shows an example of a flow of processing executed by the driving support device.

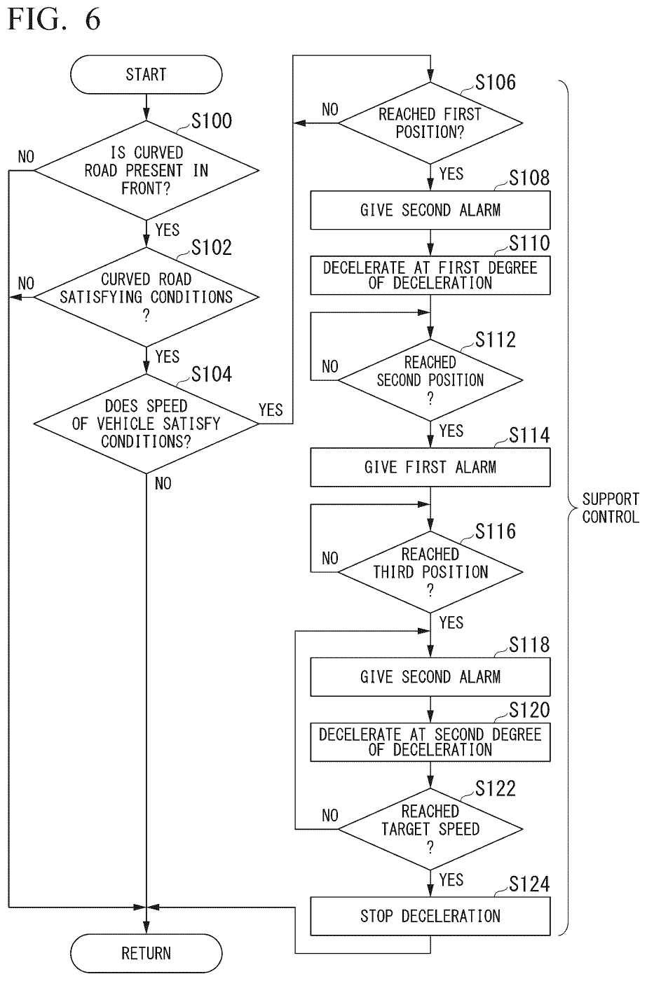

FIG. 6 is a flowchart which shows an example of processing of the first aspect of brake override, executed by the driving support device.

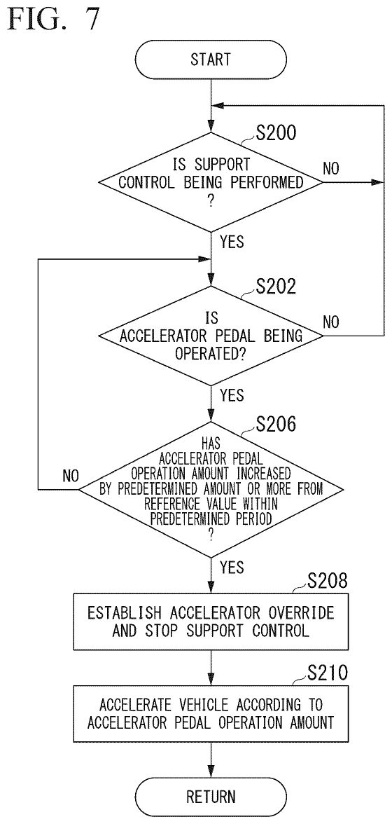

FIG. 7 is a flowchart which shows an example of processing of the second aspect of brake override, executed by the driving support device.

### DETAILED DESCRIPTION OF THE INVENTION

Hereinafter, embodiments of a vehicle control device, a vehicle control method, and a storage medium of the present invention will be described with reference to the drawings.

### Embodiment

### [Overall Configuration]

FIG. 1 is a configuration diagram of a vehicle system 1 using a vehicle control system according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, an MPU 60, a driver monitor camera 70, a driving operator 80, a driving support device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added. The driving support device 100 is an example of the “vehicle control device.”

The camera 10 is a digital camera that uses a solid-state image sensor such as a charge coupled device (CCD) or a complementary metal oxide semiconductor (CMOS). The camera 10 is attached to an arbitrary place in a vehicle in which the vehicle system 1 is mounted (hereinafter, referred to as a vehicle M). When an image of the front is captured, the camera 10 is attached to an upper part of the front windshield, a back surface of the windshield rear-view mirror, and the like. The camera 10 periodically and repeatedly captures, for example, a periphery of the vehicle M. The camera 10 may be a stereo camera.

The radar device 12 emits radio waves such as millimeter waves around the vehicle M, and detects radio waves (reflected waves) reflected by an object to detect at least a position (distance and direction) of the object. The radar device 12 is attached to an arbitrary place in the vehicle M. The radar device 12 may detect the position and speed of an object using a frequency modulated continuous wave (FM-CW) method.

The LIDAR 14 irradiates the periphery of the vehicle M with light (or electromagnetic waves with wavelengths close to that of light) and measures scattered light. The LIDAR 14 detects a distance to a target based on a time from light emission to light reception. The irradiated light is, for example, a pulsed laser beam. The LIDAR 14 is attached to an arbitrary place on the vehicle M.

The object recognition device 16 performs sensor fusion processing on a result of detection by some or all of the camera 10, the radar device 12, and the LIDAR 14, and recognizes the position, type, speed, and the like of an object. The object recognition device 16 outputs a result of recognition to the driving support device 100. The object recognition device 16 may output the results of detection by the camera 10, the radar device 12, and the LIDAR 14 to the driving support device 100 as they are. The object recognition device 16 may be omitted from the vehicle system 1.

The communication device 20 communicates with other vehicles present around the vehicle M using, for example, a cellular network, a Wi-Fi network, Bluetooth (a registered trademark), dedicated short range communication (DSRC), or the like, or communicates with various server devices via wireless base stations.

The HMI 30 presents various types of information to an occupant of the vehicle M, and also receives an input operation from the occupant. The HMI 30 includes various display devices, speakers, buzzers, touch panels, switches, keys, and the like. The HMI 30 includes a display device. The display device (display unit) is a display device that displays various types of information on the vehicle M, such as a speedometer that is provided, for example, at a center of an instrument panel of the vehicle M, and represents a traveling speed of the vehicle M or a tachometer that indicates the number of rotations (rotational speed) of an internal combustion engine included in the vehicle M, which is a so-called multi-information display.

The vehicle sensor 40 includes a vehicle speed sensor that detects a speed of the vehicle M, an acceleration sensor that detects acceleration, a yaw rate sensor that detects an angular speed around a vertical axis, a direction sensor that detects a direction of the vehicle M, and the like.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 identifies the position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determination unit 53 determines, for example, a route from the position of the vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determination unit 61, and holds second map information 62 in a storage device such as an HDD or a flash memory. The recommended lane determination unit 61 divides a route on a map provided from the navigation device 50 into a plurality of blocks (for example, divides every 100 [m] in a vehicle traveling direction), and determines a recommended lane for each block with reference to the second map information 62. The recommended lane determination unit 61 determines which numbered lane from the left to drive. When a branch place is present on the route on a map, the recommended lane determination unit 61 determines a recommended lane so that the vehicle M can travel on a reasonable route to proceed to a branch destination.

The second map information 62 is map information with higher accuracy than the first map information 54. The second map information 62 includes, for example, information on a center of a lane, information on a boundary between lanes, and the like. The second map information 62 may include road information, traffic regulation information, address information (address and zip code), facility information, telephone number information, and the like. The second map information 62 may be updated at any time by the communication device 20 communicating with other devices. The second map information 62 includes information such as a position of a curved road, a curvature of the curved road, a radius of the curved road, and a slope of the curved road. These pieces of information may be included in the first map information 54. In addition, the second map information 62 or the first map information 54 may include information indicating whether a road is a curved road subject to support control, which will be described below.

The driver monitor camera 70 is, for example, a digital camera using a solid-state imaging device such as a CCD or CMOS. The driver monitor camera 70 is attached to any location on the vehicle M at a position and orientation that allows it to image the head of an occupant seated in a driver's seat of the vehicle M (hereinafter referred to as a “driver”) from the front (in a direction in which the face is imaged). For example, the driver monitor camera 70 is attached to a top of a display device provided in a center of an instrument panel of the vehicle M. The driver monitor camera 70 outputs to the driving support device 100 an image of an interior of the vehicle M including the driver of the vehicle M from a position where it is displaced.

The driving operator 80 includes, for example, a brake pedal 82, an accelerator pedal 84, a steering wheel, an operation switch of a direction indicator, a shift lever, and other operators. A sensor that detects the amount of an operation or a presence or absence of an operation is attached to the driving operator 80, and a result of the detection is output to the driving support device 100, or some or all of the traveling drive force output device 200, the brake device 210, and the steering device 220. A steering wheel does not necessarily have to be annular, and may be in a form of a deformed steering wheel, a joystick, a button, or the like. A brake pedal sensor (BP sensor) 86 is attached to the brake pedal 82. An accelerator pedal sensor (AP sensor) 88 is attached to the accelerator pedal 84.

The BP sensor 86 detects an opening degree of the brake pedal 82, which changes according to an operation of the driver on the brake pedal 82. The AP pedal sensor 88 detects the opening degree of the accelerator pedal, which changes according to an operation of the driver on the accelerator pedal 84 of the driver.

The driving support device 100 includes, for example, a recognition unit 110, a driver recognition unit 120, a curve determination unit 130, an operation information processing unit 140, a support control unit 150, and a storage unit 190. Some or all of these functional units are realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the driving support device 100, or may be stored in a detachable storage medium such as a DVD or a CD-ROM and installed in the HDD or flash memory of the driving support device 100 by the storage medium (non-transitory storage medium) being attached to a drive device. The curve determination unit 130 is an example of a first acquisition unit, the operation information processing unit 140 is an example of a second acquisition unit, and the support control unit 150 is an example of a control unit.

The storage unit 190 is realized by, for example, an HDD, a flash memory, an electrically erasable programmable read only memory (EEPROM), a read only memory (ROM), a random access memory (RAM), or the like.

The recognition unit 110 recognizes the position of an object in the periphery of the vehicle M and states such as a speed and acceleration thereof on the basis of information input from the camera 10, the radar device 12, and the LIDAR 14 via the object recognition device 16. The position of an object is recognized as, for example, a position on absolute coordinates with a representative point (a center of gravity, a center of a drive axis, or the like) of the vehicle M as an origin, and is used for control. The position of an object may be represented by a representative point such as the center of gravity or a corner of the object, or may be represented by an area. The “states” of an object may include the acceleration or jerk of the object, or a “behavioral state” (for example, whether a lane is being changed or is about to be changed).

The recognition unit 110 recognizes, for example, a lane (a traveling lane) in which the vehicle M is traveling. For example, the recognition unit 110 recognizes a traveling lane by comparing a pattern of road division line (for example, an array of solid lines and broken lines) obtained from the second map information 62 with a pattern of road division line in the periphery of the vehicle M recognized from an image captured by the camera 10. The recognition unit 110 may also recognize a traveling lane by recognizing not only the road division line but also road boundaries including the road division line, a road shoulder, a curb, a median strip, a guardrail, and the like. In this recognition, the position of the vehicle M acquired from the navigation device 50 and a result of processing by the INS may be taken into account. The recognition unit 110 recognizes stop lines, obstacles, red lights, tollhouses, and other road events.

The recognition unit 110 recognizes the position and posture of the vehicle M with respect to a traveling lane when a traveling lane is recognized. The recognition unit 110 may recognize, for example, a deviation of a reference point of the vehicle M from a center of the lane and an angle of the vehicle M, formed with respect to a line connecting the centers of the lane in the traveling direction, as a relative position and the posture of the vehicle M with respect to the traveling lane. Instead, the recognition unit 110 may recognize the position or the like of the reference point of the vehicle M with respect to any side end (a road division line or road boundary) of the traveling lane as the relative position of the vehicle M with respect to the traveling lane.

The driver recognition unit 120 detects whether the driver is in a predetermined state on the basis of the image captured by the driver monitor camera 70. The predetermined state is a state in which hands-off lane keeping control, which will be described below, can be executed. Hands-off is a state in which the driver is not gripping a steering wheel, and hands-on is a state in which the driver is gripping the steering wheel. The state in which hands-off lane keeping control can be executed is a state in which the driver is monitoring the area ahead (or around the vehicle M). Monitoring the front means, for example, that the driver is monitoring the front so that the driver can quickly take over control of the vehicle M by the vehicle system 1 to an operation of the vehicle M by the driver. For example, monitoring the front means that the driver's line of sight is facing the front. It is determined whether the driver is hands-on or hands-off on the basis of a result of the detection of a grip sensor that detects a grip state of the steering wheel (not shown).

The curve determination unit 130 acquires first information on a curved road present in the traveling direction of the vehicle M. The first information on the curved road is, for example, information on a position of the curved road, a shape of the curved road, and the like. The curve determination unit 130 identifies the position of the curved road with respect to the vehicle M on the basis of, for example, the position of the vehicle M and the first information.

The operation information processing unit 140 acquires second information on the deceleration operation of the driver of the vehicle M. The second information is, for example, information output from the BP sensor 86 and indicating the opening degree of the brake pedal. The operation information processing unit 140 acquires information on an acceleration operation of the driver of the vehicle M. For example, the operation information processing unit 140 acquires information indicating an opening degree of an accelerator pedal output from the accelerator pedal sensor 88.

The support control unit 150 supports the driver in controlling the vehicle M. For example, the support control unit 150 automatically controls the traveling drive force output device 200 and the brake device 210 without depending on an operation of the driver, and automatically controls the speed of the vehicle M. The support control unit 150 executes so-called adaptive cruise control (ACC).

For example, when there is no other vehicle in front of the vehicle M within a predetermined distance from the vehicle M, the support control unit 150 automatically controls the traveling drive force output device 200 and the brake device 210 without depending on the operation of the driver such that the vehicle M travels at a speed set by the driver, a legal speed, or a speed preset according to a road.

For example, when there is other vehicle in front of the vehicle M within a predetermined distance from the vehicle M, the support control unit 150 automatically controls the drive force output device 200 and the brake device 210 without depending on the operation of the driver to follow the other vehicle. Following means that the vehicle M travels while maintaining a position behind the other vehicle and a predetermined distance from the other vehicle.

The support control unit 150 controls the steering device 220 so that the vehicle M does not deviate from the traveling lane. For example, the support control unit 150 controls the steering device 220 so that the vehicle M travels at or near a center of the traveling lane recognized by the recognition unit 110. The support control unit 150, for example, executes hands-off lane keeping control that can control the steering of the vehicle M even in a state where the driver is not gripping the steering wheel or hands-on lane keeping control that can control the steering of the vehicle M while the driver is gripping the steering wheel.

The support control unit 150 causes the vehicle M to automatically change lanes. For example, the support control unit 150 generates a trajectory for changing lanes, and causes the vehicle M to change lanes so that the vehicle M travels along the generated trajectory. The support control unit 150 causes the vehicle M to change lanes (ALC: automatic lane change) on the basis of a destination set for an occupant and a recommended lane output to the MPU 60.

The support control unit 150 may automatically cause the vehicle M to change lanes when an instruction of changing lanes is issued by the driver. An instruction of changing lanes is an operation of a lever part of an operation switch of a turn signal. For example, when the driver operates a lever part in a direction in which the driver wants the vehicle M to change lanes, the vehicle M changes lanes in the direction corresponding to the operation. The instruction to change lanes may be a different operation from the operation of the lever part of the operation switch of the turn signal. For example, when a predetermined operation button is pressed, a lane change may be performed. A part or all of the control of the support control unit 150 described above may be omitted.

Furthermore, when the vehicle enters a curved road or while it travels on a curved road, the support control unit 150 supports the driver such that the vehicle M can travel the curved road smoothly by causing the vehicle M to decelerate to a speed corresponding to the curved road, and notifying the driver of the deceleration. Hereinafter, this control may be referred to as support control.

The traveling drive force output device 200 outputs drive force (torque) for traveling the vehicle M to drive wheels. The traveling drive force output device 200 includes, for example, a combination of an internal combustion engine, an electric motor, a transmission, and the like, and an ECU that controls these. The ECU controls the constituents described above according to information input from the support control unit 150 or information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to the information input from the support control unit 150 or the information input from the driving operator 80 so that brake torque corresponding to a braking operation is output to each wheel.

The steering device 220 includes, for example, a steering ECU and an electric motor. For example, the electric motor applies force to a rack and pinion mechanism to change a direction of a steering wheel. The steering ECU drives the electric motor in accordance with information input from the support control unit 150 or information input from the driving operator 80 to change the direction of the steering wheel.

### [Support Control]

While the vehicle M is traveling in a section (predetermined section) from an entrance of a curved road to a predetermined distance, or while the vehicle M is traveling on the curved road, the support control unit 150 performs support control that is one or both of deceleration control that causes the vehicle M to decelerate so that the speed of the vehicle M approaches a target speed according to the curved road and notification control that issues a notification (warning) that the speed of the vehicle M approaches the target speed. Support control is processing executed when, for example, the driving support device 100 does not automatically control the speed of the vehicle M (for example, the ACC is not activated) and the driver controls the speed of the vehicle M. The target speed is a speed determined based on a shape of the curved road, a legal speed on the curved road, and the like.

A target of the support control may be a curved road that satisfies a condition. The condition is, for example, that a curve radius is within a predetermined range. The predetermined range is a curve radius that requires deceleration when the vehicle M travels.

Support control may be performed on a condition that the speed of the vehicle M is equal to or lower than a predetermined speed. The predetermined speed is a speed that does not deviate from a speed limit or a recommended speed of the curved road or roads before and after the curved road by a predetermined speed or more. The predetermined speed is, for example, a speed obtained by adding a set speed (for example, 30 km/h) to the speed limit or the recommended speed described above.

Support control may be performed when a road surface condition satisfies a standard. Satisfying the standard means that, for example, no events that affect a braking operation, such as the road surface being frozen, have occurred. For example, the recognition unit 110 may recognize the road surface condition on the basis of a result of the detection by the object recognition device 16, or the driving support device 100 may recognize the road surface condition on the basis of information provided from another device. The support control may be performed when a slope of the curved road is less than a threshold value.

FIG. 2 is a diagram for describing support control. A time T is a timing when the vehicle M reaches a position P a predetermined distance from the entrance of the curved road. The predetermined distance before is a position that is preset according to the target speed. The predetermined distance before is, for example, set at a position farther from the entrance of the curved road as a deviation between the speed and the target speed of the vehicle M increases. The predetermined distance before is set at a position where a preset time for performing a notification, a preset time for performing a first warning, and a preset time for performing a second warning can be secured when brake override or accelerator override is not performed as described below.

After passing through the position P, the vehicle M passes through positions P1, P2, and P3 in this order. A time when the vehicle M reaches the position P is a time T, a time when the vehicle M reaches the position P1 is a time T+1, a time when the vehicle M reaches the position P2 is a time T+2, and a time when the vehicle M reaches the position P3 is a time T+3. An entrance of the curved road is provided between the position P2 and the position P3. The entrance of the curved road is, for example, a position where the road (lane) begins to curve or a position where the road curves by a threshold value or more.

At the time T, when the speed of the vehicle M is higher than the target speed, the support control unit 150 performs a notification on the driver and causes the vehicle M to decelerate at the first deceleration rate. The notification is a notification that causes the driver to recognize the curved road. The notification is, for example, a notification that the vehicle M approaches a curved road with the speed of the vehicle M being higher than the target speed, or a notification that support control of causing the vehicle M to decelerate so that the speed of the vehicle M approaches the target speed has started. The notification is performed via, for example, the HMI 30. The notification may be a notification using an image, or may also be a notification using an audio or a vibration (for example, by vibrating a seatbelt).

At the time T+1, the support control unit 150 issues a first warning to the driver. The first warning is a warning that causes the driver to recognize the curved road. The first warning is, for example, a warning to the driver and is a warning to cause the vehicle M to decelerate so that the speed of the vehicle M approaches the target speed.

At the time T+2, the support control unit 150 issues a second warning to the driver, causes the vehicle M to decelerate at a second deceleration rate, and makes the speed of the vehicle M match the target speed at the time T+3. The second deceleration rate is a deceleration rate greater than the first deceleration rate. The second warning is a warning that causes the driver to recognize the curved road. The second warning is a warning for the driver, and is a warning for causing the vehicle M to decelerate so that the speed of the vehicle M approaches the target speed. The second warning is a warning with an intensity stronger than that of the first warning. The warning with a strong intensity is a warning in which the driver feels a need to decelerate more. The warning with a strong intensity is, for example, that the support control unit 150 provides an image that urges the driver to decelerate, outputs a louder sound, or applies larger vibrations to the driver.

### [Override of Deceleration Operation]

As described above, the support control unit 150 provides support for the vehicle M to travel on the curved road. As a result, it is possible to support an operation of the driver so that the vehicle M smoothly travels on the curved road at the target speed. However, there are some cases in which some drivers may find the support control by the support control unit 150 troublesome, or may intend to execute deceleration at a higher deceleration than a deceleration applied in the support control of the vehicle M.

Based on the circumstances described above, when the driver operates the brake pedal 82 by a predetermined amount or more while the support control is being performed, the support control unit 150 stops the support control and controls the brake device 210 according to the operation of the driver to cause the vehicle M to decelerate. Hereinafter, this control may be referred to as brake override. In particular, in the present embodiment, the predetermined amount is set to a value equal to or greater than the second deceleration rate. As a result, it is possible to prevent override of deceleration control from occurring in a state where deceleration is not sufficient on the curved road. First and second aspects of the brake override will be described below with reference to FIGS. 3 and 4.

FIG. 3 is a diagram for describing the first aspect of the brake override. Between the time T and the time T+2, the support control unit 150 causes the vehicle M to decelerate at the first deceleration rate and issues a notification or a first warning via the HMI 30. The driver senses a change in gravity (vertical G) with respect to the traveling direction of the vehicle M due to the deceleration of the vehicle M, and also recognizes that the vehicle is approaching a curved road by notification via the HMI or by the first warning. After that, the support control unit 150 causes the vehicle M to decelerate at the second deceleration rate at the time T+2, but it is assumed that the driver desires to decelerate the vehicle M at a stronger deceleration and operates the brake pedal 82 at a deceleration equal to or greater than a predetermined amount. At this time, the support control unit 150 maintains the second deceleration rate as a target value (broken line in FIG. 3), but when a deceleration equal to or greater than the second deceleration rate occurs due to the operation of the brake pedal 82 by the driver, a deceleration is generated according to the operation of the brake pedal 82 by the driver. Further, as a second aspect of the brake override, the support control unit 150 stops the support control when the amount of a deceleration operation of the brake pedal 82 continues to be equal to or greater than a predetermined amount for a predetermined period of time T1 or more. On the other hand, when the amount of a deceleration operation of the brake pedal 82 does not continue to be equal to or greater than the predetermined amount for the predetermined period of time T1 or more, the support control unit 150 changes the deceleration of the vehicle M to the second deceleration rate maintained as the target value and continues the support control.

In the case of FIG. 3, the support control unit 150 determines at a time T+2+T1 (T+2 #) that the amount of the deceleration operation of the brake pedal 82 has continued to be equal to or greater than the predetermined amount for a predetermined period of time T1 or more, and stops the support control. As a result, a notification and a warning are stopped, and furthermore, deceleration control by the support control unit 150 is stopped. After that, the driving support device 100 causes the vehicle M to decelerate according to the opening degree of the brake pedal (executes the brake override). As described above, according to the first aspect of the brake override, when the amount of the deceleration operation of the brake pedal 82 has continued to be equal to or greater than the predetermined amount for the predetermined period of time T1 or more, the support control is stopped and the brake override is executed. As a result, it is possible to prevent an unintended override of the deceleration control from occurring due to, for example, a reflexive deceleration operation in response to a warning by the driver. Furthermore, according to the first aspect of the brake override, when the driver operates the brake pedal 82 while the second deceleration rate is being applied, and a deceleration equal to or greater than the second deceleration rate is generated, the second deceleration rate is maintained as the target value while a deceleration according to the operation of the brake pedal 82 by the driver is generated. As a result, it is possible to execute the support control without impairing operability of the driver.

FIG. 4 is a diagram for describing the second aspect of the brake override. Between the time T and the time T+2, the support control unit 150 causes the vehicle M to decelerate at the first deceleration rate and issues a notification or a first warning via the HMI 30. The driver senses a change in gravity (vertical G) with respect to the traveling direction of the vehicle M due to the deceleration of the vehicle M, and also recognizes that the vehicle is approaching a curved road by a notification via the HMI or by a first warning. After that, the support control unit 150 causes the vehicle M to decelerate at the second deceleration rate at the time T+2, but it is assumed that the driver desires to decelerate the vehicle M at a stronger deceleration and operates the brake pedal 82 at a deceleration equal to or greater than a predetermined amount. At this time, as in the case of FIG. 3, the support control unit 150 maintains the second deceleration rate as a target value (broken line in FIG. 4) while generating a deceleration according to the operation of the brake pedal 82 by the driver when a deceleration equal to or greater than the second deceleration rate is being generated due to the operation of the brake pedal 82 by the driver. For this reason, even if the driver intends to override the deceleration control and momentarily stops the deceleration operation, since the support control unit 150 maintains the second deceleration rate as the target value, a deceleration at the second deceleration rate is generated. As a first aspect of the brake override, the support control unit 150 stops the support control when an average of the amount of a deceleration operation for the predetermined period of time T1 is equal to or greater than a predetermined amount. Here, the predetermined period of time T1 is measured starting from, for example, a timing when the amount of the deceleration operation of the brake pedal 82 becomes equal to or greater than a predetermined amount for the first time, or a timing when the driver starts operating the brake pedal 82. On the other hand, when the average value of the amount of the deceleration operation for the predetermined period of time T1 is not equal to or greater than the predetermined amount, the support control unit 150 returns the deceleration of the vehicle M to the second deceleration rate maintained as the target value, and continues the support control.

In the case of FIG. 4, the support control unit 150 determines at the time T+2+T1 (T+2 #) that the average value of the amount of the deceleration operation for the predetermined period of time T1 has become equal to or greater than the predetermined amount, and stops the support control. As a result, a notification and a warning are stopped, and furthermore, the deceleration control by the support control unit 150 is stopped. After that, the driving support device 100 causes the vehicle M to decelerate according to the opening degree of the brake pedal (executes brake override). As described above, according to the second aspect of the brake override, when the average value of the amount of the deceleration operation for the predetermined period of time T1 becomes equal to or greater than a predetermined amount, the support control is stopped and the brake override is executed. As a result, for example, even if the driver intended to override the deceleration control but momentarily stops the deceleration operation, the deceleration control can be overridden as intended. Furthermore, according to the second aspect of the brake override, when a deceleration equal to or greater than the second deceleration rate is generated by the driver operating the brake pedal 82 while the second deceleration rate is being applied, the second deceleration rate is maintained as the target value while a deceleration according to the operation of the brake pedal 82 by the driver is generated. As a result, it is possible to execute the support control without impairing the operability of the driver.

### [Flowchart]

FIG. 5 is a flowchart which shows an example of a flow of processing executed by the driving support device 100. An order of the processing in this flowchart may be changed, or some of the processing may be omitted.

First, the driving support device 100 determines whether a curved road is present a predetermined distance ahead from the position of the vehicle M (step S100). When a curved road is present, the driving support device 100 determines whether the curved road is a curved road that satisfies a condition (step S102). When the curved road is a curved road that satisfies the condition, the driving support device 100 determines whether the speed of the vehicle M satisfies the condition (step S104). When the determination in step S100, S102, or S104 is negative, processing of one routine of this flowchart ends.

If the speed of the vehicle satisfies the condition, the driving support device 100 determines whether the vehicle M has reached a first position (for example, the position P in FIG. 2) (step S106). When the vehicle M has reached the first position, the driving support device 100 issues a notification (step S108) and causes the vehicle M to decelerate at the first deceleration rate (step S110).

Next, the driving support device 100 determines whether the vehicle M has reached a second position (for example, the position P1 in FIG. 2) (step S112). When the vehicle M has reached the second position, the driving support device 100 issues a first warning (step S114). Next, the driving support device 100 determines whether the vehicle M has reached a third position (for example, the position P2 in FIG. 2) (step S116).

When the vehicle M has reached the third position, the driving support device 100 issues a second warning (step S118) and causes the vehicle M to decelerate at the second deceleration rate (step S122). Next, it is determined whether the speed of the vehicle M has reached a target speed (step S122). When the speed of the vehicle M has not reached the target speed, the processing returns to step S118. When the speed of the vehicle M has reached the target speed, the driving support device 100 stops decelerating the vehicle M (step S124). As a result, processing of one routine in this flowchart will end.

As described above, when the vehicle M and the curved road satisfy the condition, the driving support device 100 executes support control (steps S106 to S124), thereby supporting the driver so that the vehicle M can travel more smoothly on the curved road.

In the processing of the flowchart described above, when brake override is established, support control will be stopped.

FIG. 6 is a flowchart which shows an example of processing of the first aspect of the brake override, executed by the driving support device 100. First, the driving support device 100 determines whether support control is in progress (step S200). When support control is in progress, the driving support device 100 determines whether the brake pedal 82 is being operated (step S202). When it is determined that the brake pedal 82 is not being operated, the driving support device 100 returns the processing to step S200.

On the other hand, when it is determined that the brake pedal 82 is being operated, the driving support device 100 determines whether the opening degree of the brake pedal continues to be equal to or greater than a predetermined amount for a predetermined period of time or more (step S204). When it is determined that the opening degree of the brake pedal does not continue to be equal to or greater than the predetermined amount for the predetermined period of time or more, the driving support device 100 returns the processing to step S202.

When it is determined that the opening degree of the brake pedal continues to be equal to or greater than the predetermined amount for the predetermined period of time or more, the driving support device 100 determines that brake override has been established, and stops support control of the flowchart in FIG. 5 described above (step S206). Next, the driving support device 100 causes the vehicle M to decelerate according to the opening degree of the brake pedal (step S208). As a result, processing of this flowchart will end.

FIG. 7 is a flowchart which shows an example of processing of the second aspect of the brake override, executed by the driving support device 100. First, the driving support device 100 determines whether support control is in progress (step S300). When support control is in progress, the driving support device 100 determines whether the brake pedal 82 is being operated (step S302). When it is determined that the brake pedal 82 is not being operated, the driving support device 100 returns the processing to step S300.

On the other hand, when it is determined that the brake pedal 82 is being operated, the driving support device 100 determines whether an average value of the opening degree of the brake pedal over a predetermined period of time is equal to or greater than a predetermined amount (step S306). When it is determined that the average value of the opening degree of the brake pedal over the predetermined period of time is not equal to or greater than the predetermined amount, the driving support device 100 returns the processing to step S302.

When it is determined that the average value of the opening degree of the brake pedal over the predetermined period of time is equal to or greater than the predetermined amount, the driving support device 100 determines that brake override has been established, and stops support control of the flowchart in FIG. 5 (step S308). Next, the driving support device 100 causes the vehicle M to decelerate according to the opening degree of the brake pedal (step S310). As a result, the processing of this flowchart will end.

According to the embodiment described above, the support control unit 150 stops the support control when the amount of a deceleration operation is equal to or greater than a predetermined amount during the execution of a deceleration control, and the predetermined amount is set to be equal to or greater than the second deceleration rate. As a result, it is possible to control the vehicle according to an intention of the driver.

The embodiment described above can be expressed as follows.

A vehicle control device includes a storage device that has stored a program, and a hardware processor, in which the hardware processor executes a program stored in the storage device, thereby acquiring first information related to a curved road that is present in a traveling direction of a vehicle, acquiring second information including an amount of a deceleration operation of a driver of the vehicle, performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has further approached the entrance of the curved road, referring to the second information during execution of the deceleration control, and stopping the deceleration control when the amount of a deceleration operation is equal to or greater than a predetermined amount, the predetermined amount is set to be equal to or greater than the second deceleration rate.

Although modes for implementing the present invention have been described above using embodiments, the present invention is not limited to these embodiments in any way, and various modifications and substitutions can be added within a range not departing from the gist of the present invention.

What is claimed is:

1. A vehicle control device comprising:
a hardware processor,
wherein the hardware processor executes a program stored in a storage device, thereby
acquiring first information related to a curved road that is present in a traveling direction of a vehicle,
acquiring second information including an amount of a deceleration operation of a driver of the vehicle,
performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has approached further toward the entrance of the curved road,
referring to the second information during execution of the deceleration control, and stopping the deceleration control when the amount of a deceleration operation is equal to or greater than a predetermined amount, and
wherein the predetermined amount is set to be equal to or greater than the second deceleration rate.

2. The vehicle control device according to claim 1,
wherein the hardware processor stops the deceleration control when the amount of a deceleration operation has continued to be equal to or greater than the predetermined amount for a predetermined time or more.

3. The vehicle control device according to claim 1,
wherein the hardware processor stops the deceleration control when an average value of the amount of a deceleration operation for a predetermined time is equal to or greater than the predetermined amount.

4. A vehicle control method comprising:
by a computer,
acquiring first information related to a curved road that is present in a traveling direction of a vehicle,
acquiring second information including an amount of a deceleration operation of a driver of the vehicle,
performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has further approached the entrance of the curved road,
referring to the second information during execution of the deceleration control, and stopping the deceleration control when the amount of a deceleration operation is equal to or greater than a predetermined amount,
wherein the predetermined amount is set to be equal to or greater than the second deceleration rate.

5. A computer-readable non-transitory storage medium that stores a program causing a computer to execute
acquiring first information related to a curved road that is present in a traveling direction of a vehicle,
acquiring second information including an amount of a deceleration operation of a driver of the vehicle,
performing, as a deceleration control that causes the vehicle to decelerate so that a speed of the vehicle approaches a target speed based on the first information when the vehicle is traveling in a section from an entrance of the curved road to a predetermined distance before the entrance or on the curved road, a deceleration control that causes the vehicle to decelerate at a first deceleration rate when the vehicle has reached a start point of the section, and causes the vehicle to decelerate at a second deceleration rate greater than the first deceleration rate when the vehicle has further approached the entrance of the curved road,
referring to the second information during execution of the deceleration control, and stopping the deceleration control when the amount of a deceleration operation is equal to or greater than a predetermined amount,
wherein the predetermined amount is set to be equal to or greater than the second deceleration rate.
